(19) United States
(12) Patent Application Publication
(10) Pub. No.: US 2010/0020030 A1
(43) Pub. Date: Jan. 28, 2010

(54) METHOD OF MANAGING CONTENT AND ELECTRONIC APPARATUS USING THE SAME

(75) Inventors: Hyun-jin KIM, Gwangju (KR); Ji-yeon Kwak, Seoul (KR); Yong-gook Park, Yongin-si (KR); Min-kyu Park, Seongnam-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd, Suwon-si (KR)

(21) Appl. No.: 12/479,060

(22) Filed: Jun. 5, 2009

(30) Foreign Application Priority Data
Jul. 22, 2008 (KR) 2008-71107

(51) Int. Cl. G06F 3/041

(52) U.S. Cl. 345/173

(57) ABSTRACT

A method of managing content and an apparatus using the same are provided. A method of managing content includes sensing a touch on an area on which content is displayed; detecting a pressure intensity of a touched area; and generating supplementary information of the content using the detected pressure intensity. Therefore, supplementary information is set, or content is searched for according to a pressure intensity.

### CROSS-REFERENCE TO RELATED APPLICATIONS

This application claims priority under 35 U.S.C. §119(a) from Korean Patent Application No. 2008-71107, filed on Jul. 22, 2008, in the Korean Intellectual Property Office, the contents of which are incorporated herein by reference in its entirety.

### BACKGROUND OF THE INVENTION

1. Field of the Invention

The present general inventive concept relates to a method of managing content and an electronic apparatus using the same. More particularly, the present general inventive concept relates to a method of managing content using pressure, and an electronic apparatus using the same.

2. Description of the Related Art

Generally, electronic apparatuses such as an MPEG layer 3 (MP3) player retrieves images or audio from a storage unit such as flash memory or a compact hard disc drive (HDD), decode the retrieved images or audio, and reproduce the decoded images or audio.

When an electronic apparatus performs specific operations in response to a user command, a display panel, such as a liquid crystal display (LCD), displays the current operating configuration. Thus the user can easily recognize the current operating configuration.

Recently, a user command input method has been required to improve convenience for a user carrying an electronic apparatus. If various keys, buttons, or the like are added to input a user command, the size and overall volume of the electronic apparatus increases. As a result, the electronic apparatus has disadvantages such as reduced comfort when carried, and a less desirable appearance. To solve these problems, an electronic apparatus can implement a touch screen display panel, which receives a command input by a user touch.

Generally, a text input method or an icon selection method is used to tag supplementary information of content displayed on a touch screen. However, there is demand for a method for tagging supplementary information using the touch screen more efficiently than the above methods.

### SUMMARY

The present general inventive concept provides a method of managing content by setting differently supplementary information such as preferences according to a pressure intensity of a touched area, and an apparatus using the same.

Additional aspects and utilities of the present general inventive concept will be set forth in part in the description which follows and, in part, will be obvious from the description, or may be learned by practice of the general inventive concept.

The foregoing and/or other aspects and utilities of the present general inventive concept may be achieved by providing a method of managing content, including sensing a touch on an area on which content is displayed. The method further includes detecting a pressure intensity of a touched area and generating supplementary information of the content using the detected pressure intensity.

The generating of the supplementary information may generate supplementary information according to the detected pressure intensity.

The method may further include storing the generated supplementary information.

The supplementary information may include a degree of preference of the content.

The generating of the supplementary information may include generating supplementary information representing a higher degree of preference when the pressure intensity of a touched area is higher than another pressure intensity.

The generating of the supplementary information may include generating supplementary information for the content when the detected pressure intensity is greater than a predetermined intensity.

The supplementary information may be in a metadata format.

The supplementary information may include the pressure intensity of a touched area or information regarding the pressure intensity.

The foregoing and/or other aspects and utilities of the present general inventive concept may also be achieved by providing a method of managing content, including sensing a touch, detecting a pressure intensity of a touched area, searching for content corresponding to the pressure intensity of a touched area, and providing the searched content.

The searching of the content may further include searching for content using supplementary information including the pressure intensity of a touched area.

The supplementary information may be in a metadata format.

The foregoing and/or other aspects and utilities of the present general inventive concept may also be achieved by providing an electronic apparatus including a touch screen to display content and receive a touch and a pressure intensity of the touched area, and a controlling unit to detect the pressure intensity of the touched area on the touch screen and generate supplementary information of the content using the detected pressure intensity.

The controlling unit may generate the supplementary information according to the detected pressure intensity.

The apparatus may further include a storage unit, wherein the controlling unit stores the generated supplementary information in the storage unit.

The supplementary information may include a degree of preference of the content.

The controlling unit may generate supplementary information to have a higher degree of preference based on a higher pressure intensity of the touched area.

The controlling unit may generate supplementary information of the content when the detected pressure intensity is greater than a predetermined intensity.

The supplementary information may be in a metadata format.

The supplementary information may include the pressure intensity of a touched area or information regarding the pressure intensity.

The foregoing and/or other aspects and utilities of the present general inventive concept may also be achieved by providing an electronic apparatus, including a storage unit to store content, a touch screen to detect display content and receive a touch and a pressure intensity of the touched area, and a controlling unit to detect the pressure intensity of a touched area on the touch screen and search for and provide content corresponding to the detected pressure.

The storage unit may store generated supplementary information comprising a pressure intensity of a touched area and content information, and the controlling unit may search for content information that corresponds to the detected pressure intensity in the supplementary information and search for content that corresponds to the searched content information.

The supplementary information may be in a metadata format.

The content information may include a file title of the content.

The foregoing and/or other aspects and utilities of the present general inventive concept may be achieved by providing a method of managing content, including sensing a touch on a touch area which content is displayed, detecting a pressure intensity on the touched area, generating supplementary information of the content using the detected pressure intensity, storing the generated supplementary information, sensing a second touch, detecting the pressure intensity on the touched area, searching for the content corresponding to the pressure intensity of the touched area, and providing the searched content.

The generating of the supplementary information may include generating supplementary information according to the detected pressure intensity.

The generating of the supplementary information may include generating supplementary information for the content when the detected pressure intensity is greater than a predetermined intensity.

The supplementary information may include the pressure intensity of the touched area or information regarding the pressure intensity.

The supplementary information may include a degree of preference of the content.

The generating of supplementary information may include generating supplementary information of a higher degree of preference when the pressure intensity of a touched area is higher than another pressure intensity.

The supplementary information may be in a metadata format.

The searching may further include searching for content using supplementary information comprising the pressure intensity of a touched area.

The supplementary information may include content information and/or searched content information.

The content information may include, file titles of content, the creation date of content, information regarding compression codec of content, information regarding a device which photographed content, and any combination thereof.

The foregoing and/or other aspects and utilities of the present general inventive concept may be achieved by providing a computer-readable medium to contain computer-readable codes providing commands for computers to execute a process, including sensing a touch on an area which content is displayed, detecting a pressure intensity on a touched area, generating supplementary information of the content using the detected pressure intensity, storing the generated supplementary information, sensing a second touch on the touch screen, detecting a second pressure intensity on the touched area, searching for the content corresponding to the pressure intensity and the second pressure intensity of the touched area, and providing the searched content.

The foregoing and/or other aspects and utilities of the present general inventive concept may be achieved by providing an electronic apparatus including, a touch screen to receive at least one of a plurality of levels of pressure intensity, and a controlling unit to generate a signal representing information according to the received signal.

The electronic apparatus may include a storage unit to store different content information to correspond to the respective pressure intensity levels.

The touch screen may include a plurality of touch areas each to receive the plurality of levels of pressure intensity.

The information according to the received signal may include supplementary information

### BRIEF DESCRIPTION OF THE DRAWINGS

These and/or other aspects and utilities of the present general inventive concept will become apparent and more readily appreciated from the following description of the embodiments, taken in conjunction with the accompanying drawings of which:

FIG. 1 is a block diagram illustrating an MPEG layer 3 (MP3) player used as an electronic apparatus according to an exemplary embodiment of the present general inventive concept;

FIG. 2 is a flowchart illustrating a method of generating supplementary information of content using a pressure intensity of a touched area, and storing the generated information according to an exemplary embodiment of the present general inventive concept;

FIG. 3 is a flowchart illustrating a method of searching for content using a pressure intensity of a touched area according to an exemplary embodiment of the present general inventive concept;

FIG. 4 is a schematic view illustrating a method of storing generated supplementary information using a pressure intensity of a touched area according to an exemplary embodiment of the present general inventive concept;

FIG. 5 is a schematic view illustrating a method of searching for content using a pressure intensity of a touched area according to an exemplary embodiment of the present general inventive concept;

FIG. 6A is a chart illustrating the relationship between a pressure intensity and a preference as being stepped; and

FIG. 6B is a chart illustrating the relationship between a pressure intensity and a preference as being linear.

### DETAILED DESCRIPTION

Reference will now be made in detail to embodiments of the present general inventive concept, examples of which are illustrated in the accompanying drawings, wherein like reference numerals refer to the like elements throughout. The embodiments are described below in order to explain the present general inventive concept by referring to the figures.

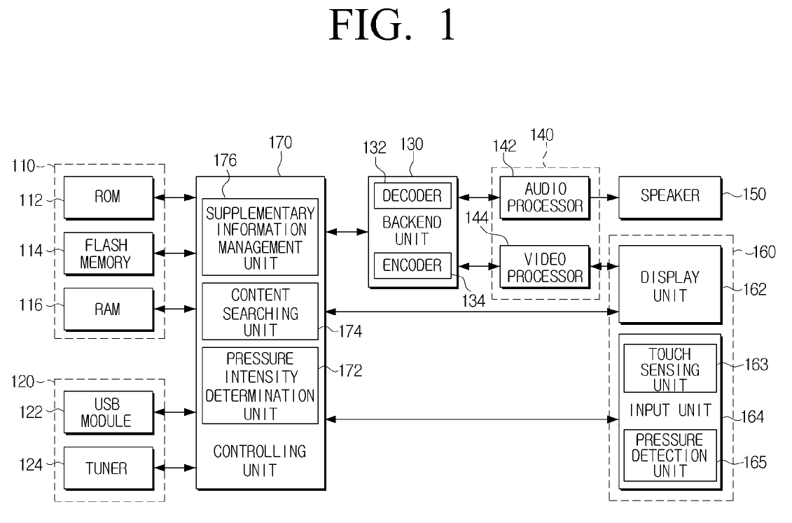

FIG. 1 is a block diagram illustrating an MPEG layer 3 (MP3) player used as an electronic apparatus according to an exemplary embodiment of the present general inventive concept. Referring to FIG. 1, an MP3 player may include a storage unit 110, a communication interface 120, a backend unit 130, a signal processor 140, a speaker 150, a touch screen 160, and a controlling unit 170.

The storage unit 110 stores information required to control the MP3 player, for example program information, content, content information, supplementary information, menu information, or icon information, and may include a Read Only Memory (ROM) 112, a flash memory 114, and a Random Access Memory (RAM) 116.

The ROM 112 stores information which should remain stored even when the MP3 is turned off, for example content information, supplementary information, menu information, icon information, program information regarding programs related to the icons, various user commands issued by a user, or any combination thereof.

The flash memory 114 stores programs to control the backend unit 130 or various updateable storage data.

The RAM 116 temporarily stores various data, and functions as a working memory of the controlling unit 170. When the MP3 player is turned off, the ROM 112 and the flash memory 114 continue to store saved data, but the RAM 116 loses stored data.

The communication interface 120 performs data communication between an external apparatus and the MP3 player, and may include a universal serial bus (USB) module 122, and a tuner 124. The USB module 122 transmits data to and receives data from a USB apparatus such as a personal computer (PC) or a USB memory stick, and processes the data. The tuner 124 receives radio or television broadcast, and transmits the received broadcast to the backend unit 130. The content related to the exemplary embodiment of the present general inventive concept may include broadcasts in addition to files including, but not limited to, still image files, moving picture files, and audio files.

The backend unit 130 processes a signal by compressing, expanding, and reproducing video and/or audio. The backend unit 130 may include a decoder 132 and an encoder 134.

Specifically, the decoder 132 decompresses a file outputted from the storage unit 110 or data outputted from the communication interface 120, and transmits audio or video to an audio processor 142 or a video processor 144, respectively. The encoder 134 compresses the audio or video input from the communication interface 120 in a predetermined format, and transmits the compressed file to the storage unit 110.

The signal processor 140 converts the input signal into a signal capable of being outputted, and may include the audio processor 142 and the video processor 144. The audio processor 142 converts a digital audio signal outputted from the backend unit 130 into an analogue audio signal, and outputs the analogue audio signal to the speaker 150. The video processor 144 processes a video signal outputted from the backend unit 130, and outputs the processed video signal to a display unit 162.

The touch screen 160 provides both functions of the display unit 162 and an input unit 164, in which the display unit 162 displays video, content such as text, or icons outputted from the video processor 144 or the controlling unit 170, and the input unit 164 receives user commands, and transmits the commands to the controlling unit 170. A user may view a menu displayed on the touch screen 160, and may simultaneously touch an area on which the menu is displayed so as to input user commands.

The input unit 164 may include a touch sensing unit 163 to sense a user's touch and a pressure detection unit 165 to detect the pressure intensity of the user's touch. The touch sensing unit 163 produces a low energy field on a predetermined area of the touch screen 160, and thus senses an energy change when a conductor, such as a portion of a human body, enters the energy field. The touch sensing unit 163 then transmits coordinate data of the touched area to the controlling unit 170. The pressure detection unit 165 detects the pressure intensity of the touched area, and transmits the detected pressure intensity to the controlling unit 170.

As used herein, the term “pressure intensity” means any amount representing a pressure applied to a designated area or point. For example, the term “pressure intensity” may include, but is not limited to, a measurement of the downward pressure or force from a human's finger onto a touch screen.

The touch sensing unit 163 may be implemented separately from the pressure detection unit 165. Moreover, the present general inventive concept is not limited thereto. It is possible that, the touch sensing unit 163 and the pressure detection unit 165 may be implemented as a single component using a pressure fusion touch sensor. The single component may be a single monolithic body or a single integrated body.

The controlling unit 170 controls overall operations of the MP3 player. If a user command is input through the input unit 164, the controlling unit 170 controls various function blocks of the MP3 player to correspond to the input command. For example, if a user inputs a command to play back a file stored in the storage unit 110, the controlling unit 170 retrieves the file from the storage unit 170, and transmits the retrieved file to the backend unit 130. The backend unit 130 then decodes the file, and the audio processor 142 and the video processor 144 process audio and video signals so that the audio and video are output via the speaker 150 and the display unit 162, respectively, under the control of the controlling unit 170.

As used herein, the term “supplementary information” means any combination of information related to any content, including but not limited to, generated supplementary information and stored supplementary information. For example, the term “supplementary information” may include, but is not limited to, a degree of preference. Additionally, the term “supplementary information” may include, but is not limited to, the pressure intensity of a touched area. Additionally, the term “supplementary information” may include, but is not limited to, information regarding the pressure intensity. Additionally, the term “supplementary information” may include, but is not limited to, content information and/or searched content information. The above examples may or may not constitute portions of the supplementary information. Part or all of the supplementary information may be generated or may be previously stored in an apparatus.

The controlling unit 170 may include a pressure intensity determination unit 172, a content searching unit 174, and a supplementary information management unit 176 in order to manage content. If a touch is sensed, the pressure intensity determination unit 172 receives a pressure intensity of the touched area from the pressure detection unit 165, and generates information regarding the pressure intensity. The pressure intensity of a touched area and information regarding the pressure intensity may be portions of the generated supplementary information, and therefore may be stored in storage unit 110 as stored supplementary information.

In this exemplary embodiment of the present general inventive concept, the pressure intensity of a touched area is classified into a first intensity, second intensity, . . . , Kth intensity, . . . , Nth intensity. The information regarding the pressure intensity may be classified into a touch level lower than the first intensity, a first level between the first and second intensities, . . . , a K level between Kth and K+1th intensity, . . . , and a N level between Nth and N+1th intensities. Each of a plurality of supplementary information corresponds to each of the levels of the respective pressure intensity of a touched area or information regarding the pressure intensity. The pressure intensity determination unit 172 determines which level a pressure intensity of a touched area detected by the pressure detection unit 165 belongs to, and transmits the determined level to the supplementary information management unit 176.

As used herein, the term “content information” means any information related to content. Content information may include, but is not limited to, file titles of content, the creation date of content, information regarding compression codec of content, information regarding a device which photographed content, and any combination thereof.

The content searching unit 174 receives a touch signal and coordinate data of the touched area from the touch sensing unit 163, determines content displayed on the touched area, retrieves content information corresponding to the content from the storage unit 110, and transmits the retrieved content information to the supplementary information management unit 176 which will be explained below. If a command to search for content is input, the content searching unit 174 receives the content information from the supplementary information management unit 176, retrieves content corresponding to the content information from the storage unit 110, and transmits the content to the backend unit 130.

The supplementary information management unit 176 may generate supplementary information including content information transmitted from the content searching unit 174 and pressure intensity information transmitted from the pressure intensity determination unit 172. Alternatively, if the supplementary information is previously stored in the storage unit 110, the supplementary information management unit 176 may update the supplementary information by adding the pressure intensity information to the supplementary information so as to manage the supplementary information. In this example, the pressure intensity information is generated supplementary information. If a command to search for content is input, the supplementary information management unit 176 may receive the pressure intensity information from the pressure intensity determination unit 172, search through supplementary information for content information that corresponds to the pressure intensity information, and output the content information to the content searching unit 174.

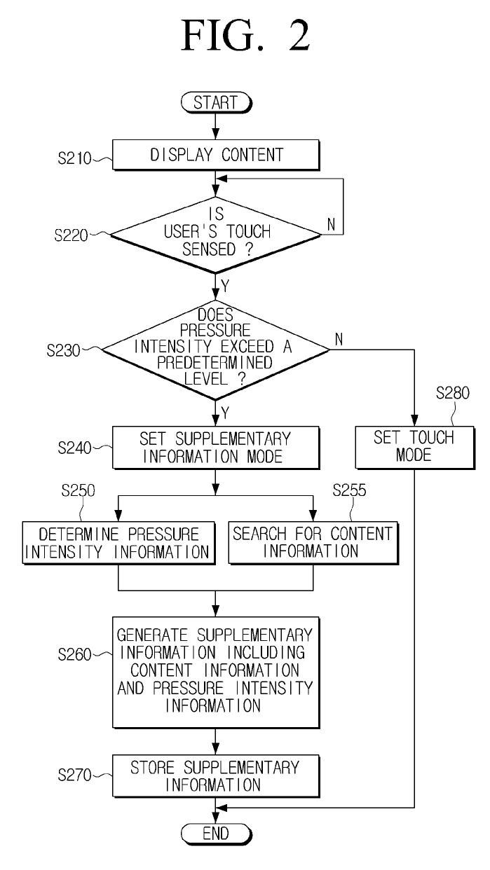

FIG. 2 is a flowchart provided to explain a method of generating supplementary information of content using a pressure intensity of a touched area, and storing the generated information according to an exemplary embodiment of the present general inventive concept.

The controlling unit 170 determines whether a user's touch is sensed while content is displayed in operations S210, 220. Specifically, a user may touch an area on which specific content is displayed with a finger or thumb while viewing specific content displayed on the touch screen 160, and thus may input a command to select the specific content. The touch sensing unit 163 of the input unit 164 transmits coordinate data of the touched area and a touch signal to the controlling unit 170, and the pressure detection unit 165 detects the pressure intensity of the touched area and transmits the detected pressure intensity to the controlling unit 170 so that the controlling unit 170 may determine that the touch screen 160 senses the touch.

If it is determined that the touch is sensed in operation S220-Y, the controlling unit 170 determines whether the input pressure intensity of a touched area exceeds a predetermined level of intensity in operation S230. The pressure intensity of the touched area detected by the pressure detection unit 165 is transmitted to the pressure intensity determination unit 172 of the controlling unit 170. The pressure intensity determination unit 172 compares the pressure intensity of the touched area with the predetermined level of intensity, and determines whether the input pressure intensity of the touched area exceeds the predetermined level of intensity. The predetermined level of intensity may be pre-stored at the time of manufacture or preset by a user.

If it is determined that the pressure intensity of a touched area exceeds a predetermined level in operation S230-Y, the controlling unit 170 sets the MP3 player to a supplementary information mode in operation S240. However, if it is determined that the pressure intensity of the touched area is lower than the predetermined level of intensity in operation S230-N, the controlling unit 170 sets the MP3 player to a touch mode in operation S280.

In the supplementary information mode, the pressure intensity determination unit 172 of the controlling unit 170 determines information regarding the pressure intensity of a touched area, and transmits the determined information regarding the pressure intensity to the supplementary information management unit 176 in operation S250. The content searching unit 174 in the controlling unit 170 determines content corresponding to the touched area, searches for content information corresponding to the content from the storage unit 110, and transmits searched content information to the supplementary information management unit 176 in operation S255.

As used herein, the term “searched content information” means any results of a search of content information. For example, the term “searched content information” may include, but is not limited to, the results of a search for content information that corresponds to specific content.

The supplementary information management unit 176 generates supplementary information regarding content using content information and pressure intensity information in operation S260. The supplementary information may be in a metadata format. Specifically, if the generated supplementary information corresponds to a preference, a supplementary information generating unit may match the above pressure intensity information with a preference. If the pressure intensity is high, the preference may also be high.

The supplementary information management unit 176 stores the generated supplementary information in the storage unit 110 in operation S270.

When information regarding the degree of user preference is stored using the pressure intensity of a touched area, the MP3 player may represent the pressure intensity using visual or audible information.

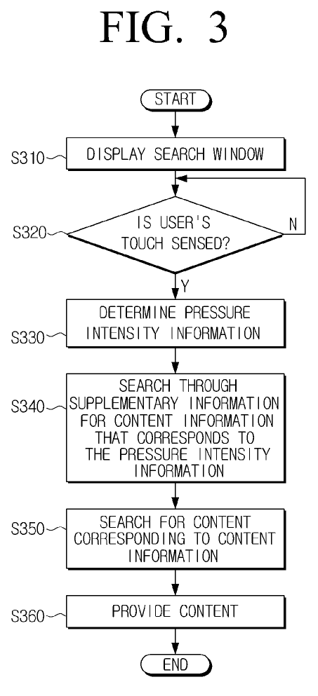

FIG. 3 is a flowchart provided to explain a method of searching for content using a pressure intensity of a touched area according to an exemplary embodiment of the present general inventive concept.

A search window is displayed in operation S310.

The controlling unit 170 determines whether an area on which the search window is displayed is touched in operation S320. A user may touch an area of the touch screen 160 on which the search window is displayed with a finger or thumb, and thus input a command to search for content. The pressure detection unit 165 of the input unit 164 detects a pressure intensity of the touched area, and transmits the detected pressure intensity to the controlling unit 170, and the controlling unit 170 determines that the touch screen 160 is touched.

If it is determined that the touch is sensed in operation S320-Y, the pressure intensity determination unit 172 of the controlling unit 170 receives the pressure intensity of the touched area from the pressure detection unit 165, determines information regarding the pressure intensity, and transmits the determined pressure intensity information to the supplementary information management unit 176 in operation S330.

The supplementary information management unit 176 searches through supplementary information for content information that corresponds to the pressure intensity information, and transmits searched content information to the content searching unit 174 in operation S340.

The content searching unit 174 searches for content corresponding to the content information from the storage unit 110 in operation S350.

The MP3 player provides searched content in operation S360. Specifically, the content searching unit 174 searches for content from the storage unit 110, transmits searched content to the backend unit 130, then the backend unit 130 decodes the received content and transmits the decoded content to the signal processing unit 140. Then, the signal processing unit 140 processes the content to be output, and outputs the processed content to the display unit 162 and/or the speaker 150.

As used herein, the term “searched content” means any results of a search of content. For example, the term “searched content” may include, but is not limited to, the results of a search for content that corresponds to a pressure intensity of a touched area.

If a user searches for content using a pressure intensity of a touched area, the pressure intensity is not indicated in a visual or audible form in this exemplary embodiment of the present general inventive concept. However, the MP3 player may indicate the pressure intensity of a touched area using a visual or audible form.

In this exemplary embodiment of the present general inventive concept, if pressure of a certain pressure intensity of a touched area is input on the searching window, content corresponding to the pressure intensity is provided. However, this is merely an exemplary embodiment of the present general inventive concept. A plurality of content may also be arranged according to the pressure intensity of a touched area.

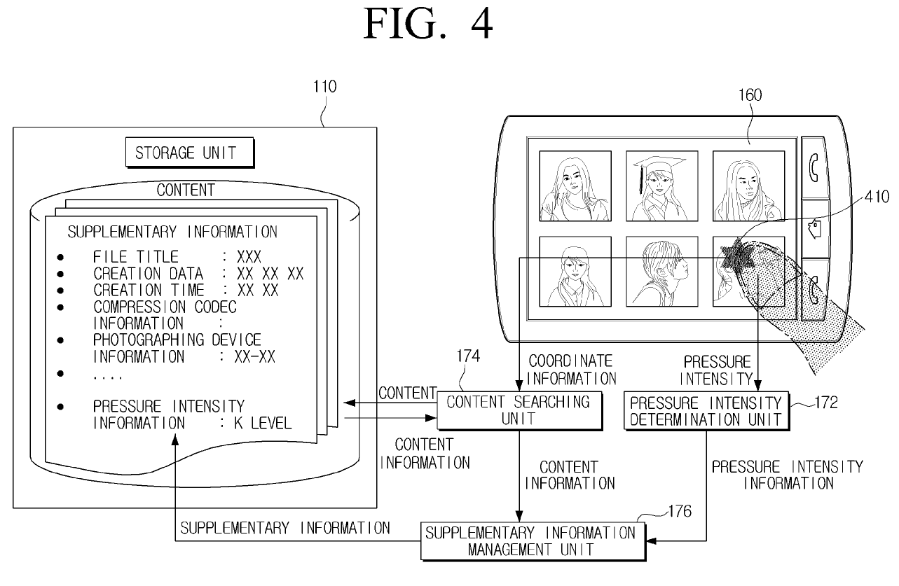

FIG. 4 is a schematic view illustrating a method of storing supplementary information using a pressure intensity of a touched area according to an exemplary embodiment of the present general inventive concept.

Referring to FIG. 4, if at least one piece of content is displayed on the touch screen 160, and if a user desires to set specific content to be preferred content, the user may press an area on which the specific content is displayed with his or her finger or thumb. The pressure intensity of the touched area is determined by tactile means, but the MP3 player may display the pressure intensity of a touched area in a visual form 410. A user may also set the pressure intensity of a touched area according to the degree of preference of content. For example, a user may set the pressure intensity of a touched area corresponding to specific content to be high so that the specific content has a high degree of preference. The pressure intensity of the touched area is transmitted to the pressure intensity determination unit 172, and coordinate data of the touched area is transmitted to the content searching unit 174.

The pressure intensity determination unit 172 determines information regarding the pressure intensity of a touched area, and transmits the information to the supplementary information management unit 176. The content searching unit 174 determines content corresponding to the touched area using coordinate data, searches for content information or supplementary information corresponding to the content from the storage unit 110, and transmits the searched content information and/or the searched supplementary information to the supplementary information management unit 176.

As used herein, the term “searched supplementary information” means any results of a search of supplementary information. For example, the term “searched supplementary information” may include, but is not limited to, the results of a search for supplementary information that corresponds to specific content.

The supplementary information management unit 176 generates supplementary information of the content using content information and pressure intensity information, or if the supplementary information has already been provided, the supplementary information management unit 176 updates the supplementary information by adding the pressure intensity information, and stores the updated supplementary information in the storage unit 110.

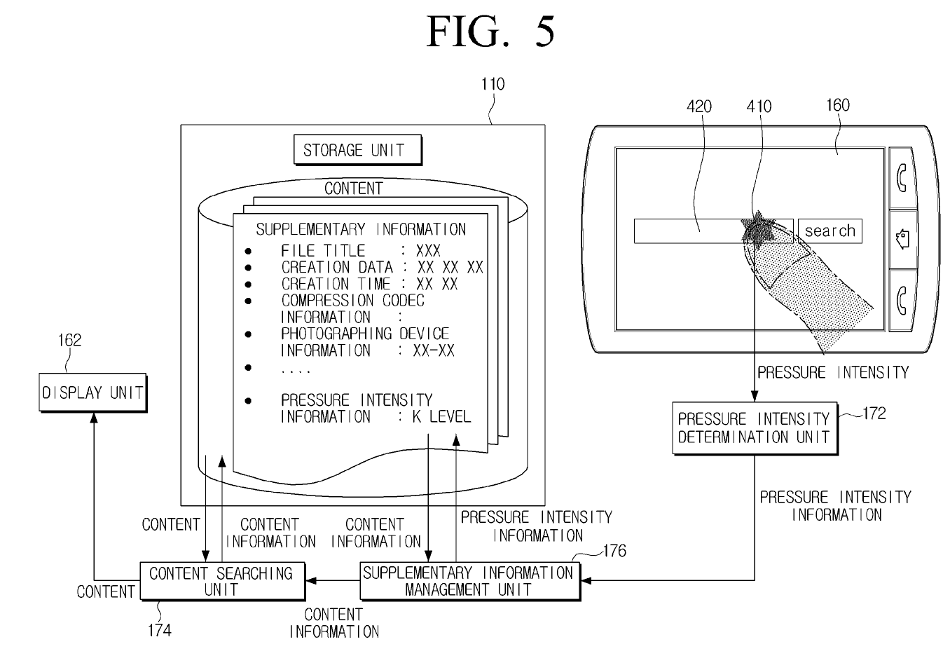

FIG. 5 is a schematic view illustrating a method of searching for content using a pressure intensity of a touched area according to an exemplary embodiment of the present general inventive concept.

Referring to FIG. 5, a search window 420 is displayed on the touch screen 160. A user touches the search window 420 using his or her finger or thumb, and pressures the touched area in order to search for content corresponding to a predetermined pressure intensity. The MP3 player provides the visual form 410 regarding the pressure intensity of the touched area, and thus a user can easily recognize the pressure intensity. The pressure intensity of the touched area is transmitted to the pressure intensity determination unit 172, and the pressure intensity determination unit 172 determines information regarding the pressure intensity, and transmits the determined pressure intensity information to the supplementary information management unit 176. The supplementary information management unit 176 searches through the supplementary information for content information that corresponds to the pressure intensity information, and transmits the searched content information and/or the searched pressure intensity information to the content searching unit 174. The content searching unit 174 searches for content from the storage unit 110 using the content information, and transmits the searched content to the backend unit 130. The searched content is output to the decoder 132 and the video processor 144, and thus displayed on the display unit 162.

As used herein, the term “searched pressure intensity information” means any results of a search of pressure intensity information. For example, the term “searched pressure intensity information” may include, but is not limited to, the results of a search for pressure intensity information that corresponds to content information.

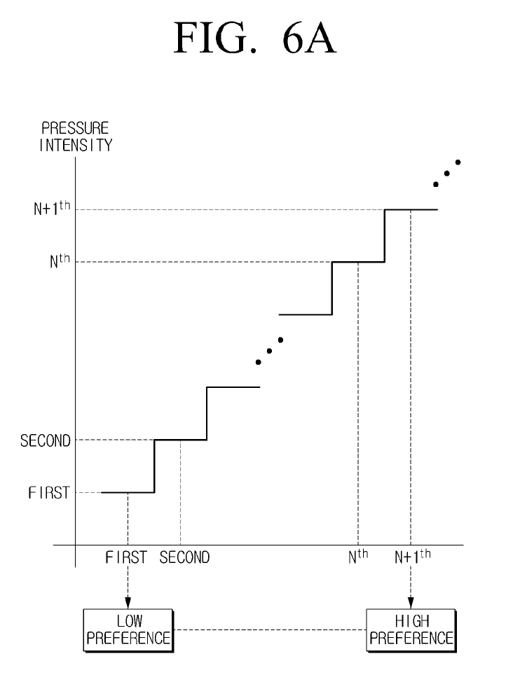

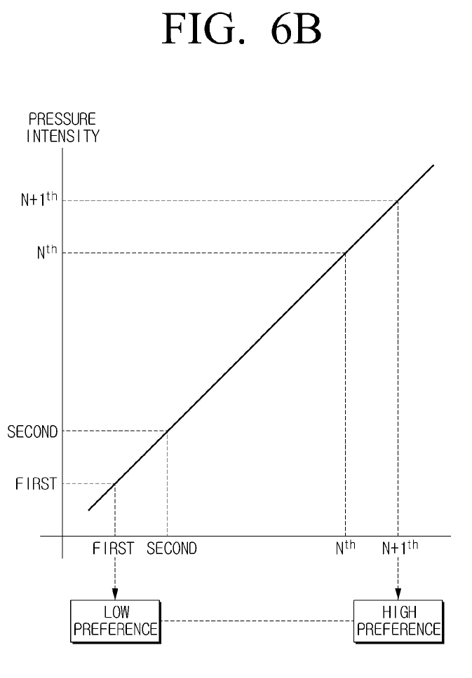

FIG. 6A is a chart illustrating the relationship between a pressure intensity and a preference as being stepped.

Referring to FIG. 6A, a first pressure intensity refers to a first preference. A second pressure intensity is the next step in the chart, and refers to a second preference. This pattern continues so that a Nth pressure intensity refers to a Nth preference, and a N+1th pressure intensity refers to a N+1th preference. The higher the number of the pressure intensity, the higher the preference. For example, a pressure intensity of N is greater than a pressure intensity of 2. Similarly, the higher the number of the preference, the higher the degree of the preference. For example, a preference of N is of a greater degree than a preference of 2. Therefore, content with a preference of N has a higher degree of preference than content with a preference of 1.

Referring to FIG. 6B, a first pressure intensity refers to a first preference. A second pressure intensity is the next step in the chart, and refers to a second preference. This pattern continues so that a Nth pressure intensity refers to a Nth preference, and a N+1th pressure intensity refers to a N+1th preference. The higher the number of the pressure intensity, the higher the preference. For example, a pressure intensity of N is greater than a pressure intensity of 2. Similarly, the higher the number of the preference, the higher the degree of the preference. For example, a preference of N is of a greater degree than a preference of 2. Therefore, content with a preference of N has a higher degree of preference than content with a preference of 1.

As described above, generated supplementary information of content, for example a degree of preference, is generated and stored using a pressure intensity of a touched area, and also content is searched. Accordingly, a user may manipulate electronic apparatuses in various manners.

The pressure intensity of a touched area detected by the pressure detection unit 165 is converted into a level having predetermined pressure intensities in this exemplary embodiment of the present general inventive concept. However, this is merely an exemplary embodiment of the present general inventive concept. The pressure intensity of the touched area may also be stored itself. Specifically, the supplementary information may include the pressure intensity of a touched area or pressure intensity information in which the pressure intensity is converted to a level having predetermined pressure intensities.

If a user searches for content, electronic apparatuses may provide content corresponding to a predetermined level including the input pressure intensity.

When an electronic apparatus provides content, pressure intensities are grouped, and the content corresponding to the grouped pressure intensities may be provided. Such a feature may be implemented to be set by a user.

An exemplary embodiment of the present general inventive concept may be applied to any electronic apparatus using a touch screen in addition to an MP3 player. The supplementary information may include any information related to any content in addition to a degree of preference.

The present general inventive concept can also be embodied as computer-readable codes on a computer-readable medium. The computer-readable medium can include a computer-readable recording medium and a computer-readable transmission medium. The computer-readable recording medium is any data storage device that can store data as a program which can be thereafter read by a computer system. Examples of the computer-readable recording medium include read-only memory (ROM), random-access memory (RAM), CD-ROMs, magnetic tapes, floppy disks, and optical data storage devices. The computer-readable recording medium can also be distributed over network coupled computer systems so that the computer-readable code is stored and executed in a distributed fashion. The computer-readable transmission medium can transmit carrier waves or signals (e.g., wired or wireless data transmission through the Internet). Also, functional programs, codes, and code segments to accomplish the present general inventive concept can be easily construed by programmers skilled in the art to which the present general inventive concept pertains.

As described above, according to an exemplary embodiment of the present general inventive concept, supplementary information may be set differently according to a pressure intensity of a touched area. Therefore, a user may manage content in an intuitive input manner.

A pressure intensity of a touched area is used to search for content, and thus a user can search for content more conveniently.

Although various embodiments of the present general inventive concept have been illustrated and described, it will be appreciated by those skilled in the art that changes may be made in these embodiments without departing from the principles and spirit of the general inventive concept, the scope of which is defined in the appended claims and their equivalents.

What is claimed is:

1. A method of managing content, comprising:
sensing a touch on a touch area on which content is displayed;
detecting a pressure intensity of the touched area; and
generating supplementary information of the content using the detected pressure intensity.

2. The method of claim 1, wherein the generating of the supplementary information includes generating supplementary information according to one of a plurality of levels of the detected pressure intensity.

3. The method of claim 1, further comprising:
storing the generated supplementary information.

4. The method of claim 1, wherein the supplementary information comprises a degree of preference of the content.

5. The method of claim 4, wherein the generating of the supplementary information comprises:
generating supplementary information of a higher degree of preference when the pressure intensity is higher than another pressure intensity.

6. The method of claim 1, wherein the generating of supplementary information comprises:
generating supplementary information for the content when the detected pressure intensity is greater than a predetermined intensity.

7. The method of claim 1, wherein the supplementary information is in a metadata format.

8. The method of claim 1, wherein the supplementary information comprises the pressure intensity of the touched area or information regarding the pressure intensity.

9. A method of managing content, comprising:
sensing a touch,
detecting a pressure intensity of a touch area;
searching for content corresponding to the pressure intensity of the touched area; and
providing the searched content.

10. The method of claim 9, wherein the searching for content comprises:
searching for content using supplementary information comprising the pressure intensity of the touched area.

11. The method of claim 10 wherein the supplementary information is in a metadata format.

12. An electronic apparatus, comprising:
a touch screen to display content and receive a touch and a pressure intensity of the touched area; and
a controlling unit to detect the pressure intensity of the touched area on the touch screen and generate supplementary information of the content using the detected pressure intensity.

13. The apparatus of claim 12, wherein the controlling unit generates the supplementary information according to the detected pressure intensity.

14. The apparatus of claim 12, further comprising: a storage unit, wherein the controlling unit stores the generated supplementary information in the storage unit.

15. The apparatus of claim 12, wherein the supplementary information comprises a degree of preference of the content.

16. The apparatus of claim 15, wherein the controlling unit generates supplementary information of a higher degree of preference when the pressure intensity is higher than another pressure intensity.

17. The apparatus of claim 12, wherein the controlling unit generates supplementary information for the content when the detected pressure intensity is greater than a predetermined intensity.

18. The apparatus of claim 12, wherein the supplementary information is in a metadata format.

19. The apparatus of claim 12, wherein the supplementary information comprises the pressure intensity of a touched area or information regarding the pressure intensity.

20. An electronic apparatus, comprising:
a storage unit to store content;
a touch screen to display content and receive a touch and a pressure intensity; and
a controlling unit to detect the pressure intensity of a touched area on the touch screen and search the storage unit for content corresponding to the detected pressure intensity, and provide the searched content.

21. The apparatus of claim 20, wherein the storage unit stores generated supplementary information comprising a pressure intensity and content information, and the controlling unit searches for content information that corresponds to the detected pressure intensity in the supplementary information, and searches for content corresponding to the searched content information.

22. The apparatus of claim 21, wherein the supplementary information is in a metadata format.

23. The apparatus of claim 21, wherein the content information comprises a file title of the content.

24. A method for managing content, comprising:
sensing a touch on a touch area which content is displayed,
detecting a pressure intensity on the touched area,
generating supplementary information of the content using the detected pressure intensity,
storing the generated supplementary information,
sensing a second touch from the touch area,
detecting a second pressure intensity on the touched area,
searching for the content corresponding to the pressure intensity and the second pressure intensity of the touched area,
and providing the searched content.

25. The method of claim 24, wherein the generating of the supplementary information includes generating supplementary information according to the detected pressure intensity.

26. The method of claim 24, wherein the generating of the supplementary information includes generating supplementary information for content when the detected pressure intensity is greater than a predetermined intensity.

27. The method of claim 24, wherein the generated supplementary information comprises the pressure intensity of a touched area or information regarding the pressure intensity.

28. The method of claim 24, wherein the supplementary information comprises a degree of preference of the content.

29. The method of claim 28, wherein the generating of the supplementary information comprises generating supplementary information of a higher degree of preference when the pressure intensity is higher than another pressure intensity.

30. The method of claim 24, wherein the supplementary information is in a metadata format.

31. The method of claim 24, wherein the searching for the content comprises searching for content using the supplementary information.

32. The method of claim 31, wherein the supplementary information comprises content information.

33. The method of claim 32, wherein the supplementary information further comprises searched content information.

34. The method of claim 33, wherein content information is selected from a group consisting of: file titles of content, creation date of content, information regarding compression codec of content, information regarding a device which photographed content, and any combination thereof.

35. A computer-readable medium to contain computer-readable codes providing commands for computers to execute a process including:
sensing a touch on a touch area which content is displayed,
detecting a pressure intensity on a touched area,
generating supplementary information of the content using the detected pressure intensity,
storing the generated supplementary information,
sensing a second touch on the touch screen,
detecting a second pressure intensity of the touched area,
searching for the content corresponding to the pressure intensity and the second pressure intensity of the touched area, and providing the searched content.

36. An electronic apparatus comprising:
a touch screen to receive at least one of a plurality of levels of pressure intensity; and
a controlling unit to generate a signal representing information according to the received signal.

37. The electronic apparatus of claim 36, further comprising:
a storage unit to store different content information to correspond to the respective pressure intensity levels.

38. The electronic apparatus of claim 37, wherein the touch screen comprises a plurality of touch areas each to receive the plurality of levels of pressure intensity.

39. The electronic apparatus of claim 38, wherein the information according to the received signal is supplementary information.
